(19) United States
(12) Patent Application Publication
(10) Pub. No.: US 2026/0142590 A1
(43) Pub. Date: May 21, 2026

(54) MULTILEVEL CONVERTER TOPOLOGIES FOR SWITCHED RELUCTANCE MOTOR DRIVES AND METHODS OF OPERATING THE SAME

(71) Applicant: ENEDYM INC., Hamilton (CA)

(72) Inventors: Nasir Ali, Hamilton (CA); Mehdi Narimani, Oakville (CA)

(21) Appl. No.: 19/395,535

(22) Filed: Nov. 20, 2025

Related U.S. Application Data
(60) Provisional application No. 63/722,655, filed on Nov. 20, 2024.

(51) Int. Cl. H02M 7/487; H02M 1/00; H02M 1/14; H02M 1/44; H02M 7/483; H02M 7/539

(52) U.S. Cl. CPC H02M 7/487; H02M 7/4835; H02M 7/4837; H02M 7/539; H02M 1/0054; H02M 1/14; H02M 1/44

(57) ABSTRACT

Embodiments herein generally relate to several multilevel inverters topologies are methods of operating the same. In at least one embodiment, a multilevel converter system for driving a switched reluctance motor (SRM) is disclosed where the system comprises a front-end circuit coupled to a DC supply voltage, the front-end circuit comprising a respective plurality of switching elements and a plurality of diodes; a back-end circuit coupled to the front-end circuit, the back-end circuit comprising a respective plurality of switching elements; a plurality of phase leg circuits, each phase leg circuit corresponding to a respective phase winding of the SRM, each phase leg circuit comprising the front-end circuit entirely and a subset of the switching elements from the back-end circuit; and a controller configured to selectively control the switching elements and diodes of the front-end circuit and of the subset of the back-end circuit forming each phase leg circuit to generate a plurality of selectable voltage levels for operating the SRM in a plurality of operating modes.

### CROSS-REFERENCE TO RELATED APPLICATION(S)

This application claims the benefit of U.S. Provisional Patent Application No. 63/722,655 filed Nov. 20, 2024 entitled “MULTILEVEL CONVERTER TOPOLOGY METHOD THEREOF FIELD”. The contents of U.S. Provisional Patent Application No. 63/722,655 is hereby incorporated herein by reference in its entirety.

### FIELD

The present disclosure generally relates to power electronics for motor drive systems, and more particularly to multilevel converter topologies for switched reluctance motor (SRM) drives in traction applications, including electric vehicles.

### INTRODUCTION

The following is not an admission that anything discussed below is part of the prior art or part of the common general knowledge of a person skilled in the art.

Switched reluctance motors (SRMs) are gaining significant interest from transportations, aerospace, and renewable energy industries due to their simple and rugged rotor structure without permanent magnets or windings. However, conventional topologies of SRM drives, such as, for example, a standard two-level asymmetric half-bridge converter (AHB) topology provides limited voltage selection, resulting in degraded performance across different operating regions.

Multilevel converters can improve SRM performance by providing more voltage levels, reducing ripple, losses, and electromagnetic interference (EMI). However, existing multilevel solutions, such as ANPC, flying-capacitor, and modular multilevel converters, require numerous switches, clamping diodes, or capacitors that must be pre-charged and balanced. These added components significantly increase cost, size, and implementation complexity, making such converters unsuitable for low-voltage SRM applications, such as in electric/hybrid vehicles.

Voltage-boosting approaches for AHB converters can improve high-speed operation but introduce higher device voltage ratings and risks of overcharging the boosting capacitor. Other solutions, such as decentralized battery-based converters or asymmetric flying-capacitor topologies, also greatly increase cost and complexity and suffer from capacitor balancing challenges.

Accordingly, there remains a need for multilevel SRM converter topologies that provide flexible voltage generation with reduced cost, size, and control complexity.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In various embodiments disclosed herein, there is provided several multilevel inverters topologies and methods of operating the same. The disclosed topologies significantly improve the system level performance by increasing the fault-tolerance, reducing the current ripple, torque ripples and the subsequent noise in SRM drives. These newly developed converters achieve performance similar to the existing multilevel converters while drastically minimizing component requirements. In accordance with an aspect, five multilevel converter topologies are disclosed herein.

In accordance with one embodiment disclosed herein, a front-end circuit is developed that is cascaded to a standard AHB converter without altering the structure of the standard circuit, thereby enabling multilevel voltage generation and offering a promising solution for low-voltage industrial applications.

In accordance with another embodiment disclosed herein, a converter topology for an SRM is provided. A multilevel voltage link is generated in the topology by dividing the DC link using capacitor banks. The front-end of the circuit consists of two switches and two diodes coupled to the DC link. The front-end circuit is connected to the standard asymmetric half-bridge (AHB) converter to develop a simplified three-level neutral point clamped converter topology (SANPC). A phase-leg in an AHB converter consists of two switches and two diodes, while the developed front-end circuit consisting of two switches and two diodes are shared with all the phases.

In accordance with another embodiment disclosed herein, a three-level converter topology based on conventional flying (FC) capacitor is provided. A front-end circuit to the standard AHB converter is developed that generates three voltage levels. The front-end topology consists of two switches, two diodes and one capacitor bank. This topology is shared with all the phases of an SRM to reduce the component counts while achieving high performance. Four switches and four diodes are involved in the excitation of at least one phase.

In accordance with another embodiment a modular three-level converter topology is provided. In some cases, this topology is built by using a six-pack IGBT commercial module, and three half-bridge modules. The one end of each phase winding is connected to the mid-point of a neutral point clamped converter leg to produce multilevel voltages. The converter consists of twelve switches, two diodes and two capacitor banks.

In accordance with yet another embodiment disclosed herein, a modular fault-tolerant topology is provided, where the phase windings are reconfigurable online as series or parallel connection. The converter consists of two six-packs, and three half-bridge IGBT modules. It generates three-level voltages for SRM energization. The SRM drive operates normally if one entire six-pack module is faulted, proving extreme fault-tolerance.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments but should be given the broadest interpretation consistent with the description as a whole.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a schematic diagram of a conventional asymmetric half-bridge (AHB) converter for SRM drives, in accordance with an example.

FIG. 2A is a schematic diagram of a conventional AHB converter in one mode of operation, in accordance with an example.

FIG. 2B is a schematic diagram of a conventional AHB converter in another mode of operation, in accordance with an example.

FIG. 2C is a schematic diagram of a conventional AHB converter in a further mode of operation, in accordance with an example.

FIG. 3 is a schematic diagram of a conventional asymmetric neutral point diode clamped (ANPC) multilevel converter for SRM drives, in accordance with an example.

FIG. 4 is a schematic diagram of a conventional asymmetric flying capacitor topology for SRM drives, in accordance with an example.

FIG. 5 is a schematic diagram of a universal multilevel voltage generation circuit for SRM drives, in accordance with an example.

FIG. 6 is a schematic diagram of an improved simplified ANPC (SANPC) topology for SRM drives, in accordance with an example.

FIG. 7 is a schematic diagram of an improved flying capacitor (SFC) topology for SRM drives, in accordance with an example.

FIG. 8 is a schematic diagram of a modular three-level topology for SRM drives, in accordance with an example.

FIG. 9 is a schematic diagram of a modular three-level topology for SRM drives, in accordance with another example.

FIG. 10 is a schematic diagram of a multilevel converter with voltage boosting for high-speed operation for SRM drives, in accordance with an example.

FIG. 11 is a schematic diagram of an improved multilevel converter with voltage boosting topology for SRM drives, in accordance with an example.

FIG. 12 is a block diagram of a current chopping control for SRM drives, in accordance with an example.

FIG. 13 is a graph showing simulation waveforms for a SANPC topology at 500 rpm, in accordance with an example.

FIG. 14 is a graph showing a comparison of simulation waveforms of current ripple and a torque ripple between an AHB converter and SANPC topology, in accordance with an example.

FIG. 15 is a graph showing simulation waveforms for a SFC topology at 1500 rpm, in accordance with an example.

FIG. 16 is a graph showing a comparison of simulation tests with an AHB converter and SANPC topology at 2000 rpm, in accordance with an example.

FIG. 17 is a graph showing simulation results at 2000 rpm, in accordance with an example.

FIG. 18 is a graph showing three-phase current under parallel winding connection, in accordance with an example.

FIG. 19A is a graph showing simulation waveforms for a voltage boosting converter, in accordance with an example.

FIG. 19B is a graph showing a comparison of simulation tests with an AHB converter and a voltage boosting topology, in accordance with an example.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

It should also be noted that the terms “coupled” or “coupling” as used herein can have several different meanings depending in the context in which these terms are used. For example, the terms coupled or coupling can have a mechanical, fluidic or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore, coupled electrical elements may send and/or receive data.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof. In effect, this term means that “at least one of” or “one or more” of the listed items is used or present.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies. In addition, all ranges given herein include the end of the ranges and also any intermediate range points, whether explicitly stated or not.

In embodiments comprising an “additional” or “second” component, the second component as used herein is chemically different from the other components or first component. A “third” component is different from the other, first, and second components, and further enumerated or “additional” components are similarly different.

These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Exemplary communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The abbreviation, “e.g.” is derived from the Latin exempli gratia and is used herein to indicate a non-limiting example. Thus, the abbreviation “e.g.” is synonymous with the term “for example.” The word “or” is intended to include “and” unless the context clearly indicates otherwise.

It will be understood that any component defined herein as being included may be explicitly excluded by way of proviso or negative limitation, such as any specific compounds or method steps, whether implicitly or explicitly defined herein.

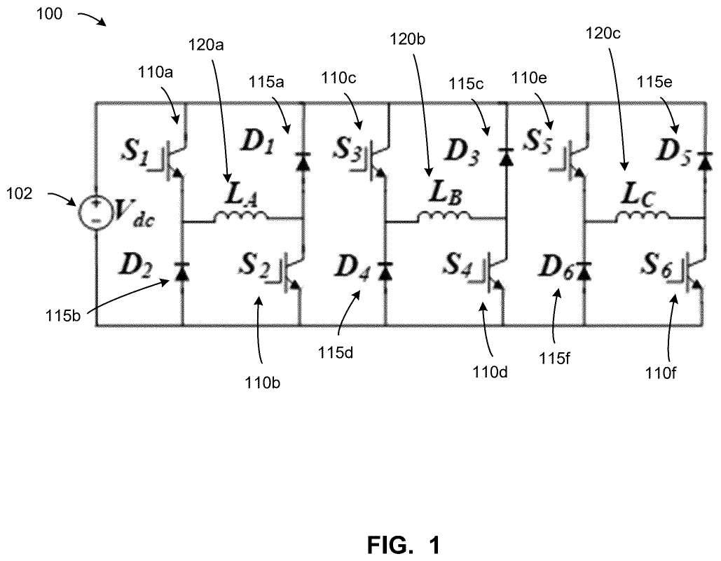

Reference is made to FIG. 1, which illustrates a two-level asymmetric half-bridge (AHB) converter 100 for SRM drives, in accordance with an example embodiment. In the illustrated embodiment, the AHB converter 100 includes a DC voltage source 102, plurality of switches, including a first switch 110a, a second switch 110b, a third switch 110c, a fourth switch 110d, a fifth switch 110e and a sixth switch 110f. The AHB converter 100 further comprises a plurality of diodes, including a first diode 115a, a second diode 115b, a third diode 115c, a fourth diode 110d, a fifth diode 110e and a sixth diode 110f. The illustrated AHB converter further includes a first inductive element 120a representing the first phase winding, a second inductive element 120b representing the second phase winding and a third inductive element 120c representing the third phase winding.

In the illustrated embodiment, the switches 110a-110f and diodes 115a-115f are interconnected to form three asymmetric half-bridge phase legs, each corresponding to one phase of the SRM. Each phase leg comprises two switches and two diodes, where each phase leg sub-circuit is coupled in parallel to the DC voltage source 102 and other phase leg sub-circuits.

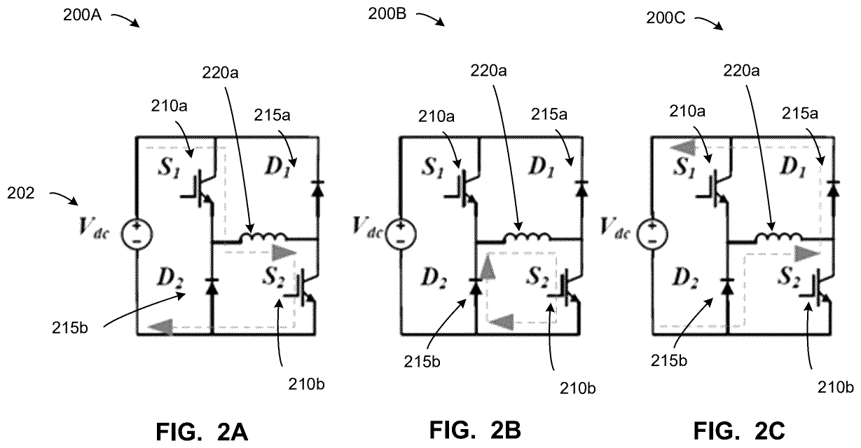

The AHB converter 100 can operate in three modes of operation, as illustrated with reference to a phase leg in FIGS. 2A-2C. FIG. 2A illustrates a magnetization mode topology 200A of a phase leg, FIG. 2B illustrates a freewheeling mode topology 200B of the phase leg and FIG. 2C illustrates a demagnetization mode topology 200C of the phase leg. DC voltage source 202, a first switch 210a, a second switch 210b, a first diode 215a, a second diode 215b, and a first inductive element 220a of FIGS. 2A-2C are analogous to the DC voltage source 102, the first switch 110a, the second switch 110b, the first diode 115a, the second diode 115b, and the first inductor 120a of FIG. 1.

Typically, standard two-level AHB converter topologies provide cost reduction and efficiency improvement of the SRM drive systems. However, with the two-level converters, the limited voltage level selection according to the operating regions causes performance degradation. Under the constant dc-link voltage, the winding inductance decreases to generate larger phase current with the increase in the power rating of the SRM drive system. With lower inductance, the switching frequency increases to limit the current ripple. While at lower power rating operation, the full dc-link voltage causes high rate of change of current and thus high current ripple. The increase of the switching frequency or current ripple introduces higher switching losses of power devices, iron losses, as well as higher winding losses due to the skin and proximity effects. Moreover, the undesirable voltage at lower power ratings, increases the voltage stress across the devices and decreases the reliability of the converter. Therefore, the two-level converters are not useful for high performance low-voltage SRM drives utilized in electric/hybrid vehicles.

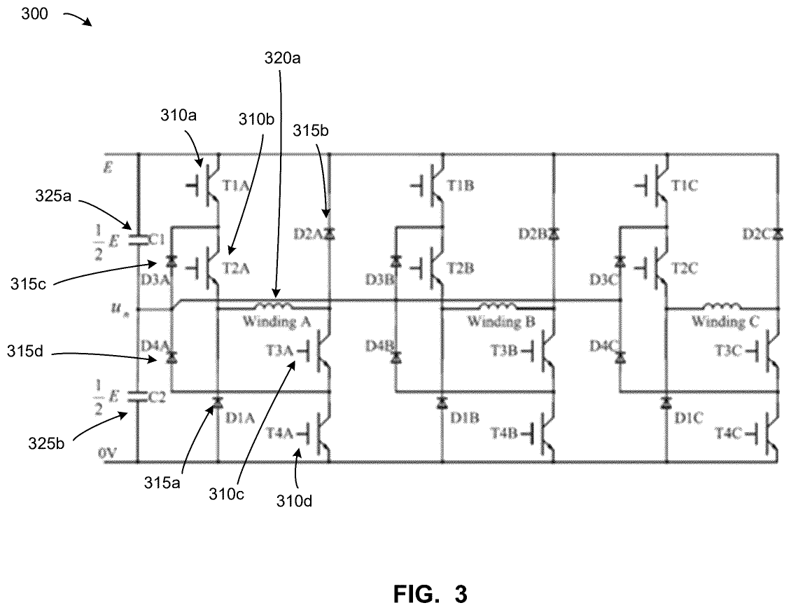

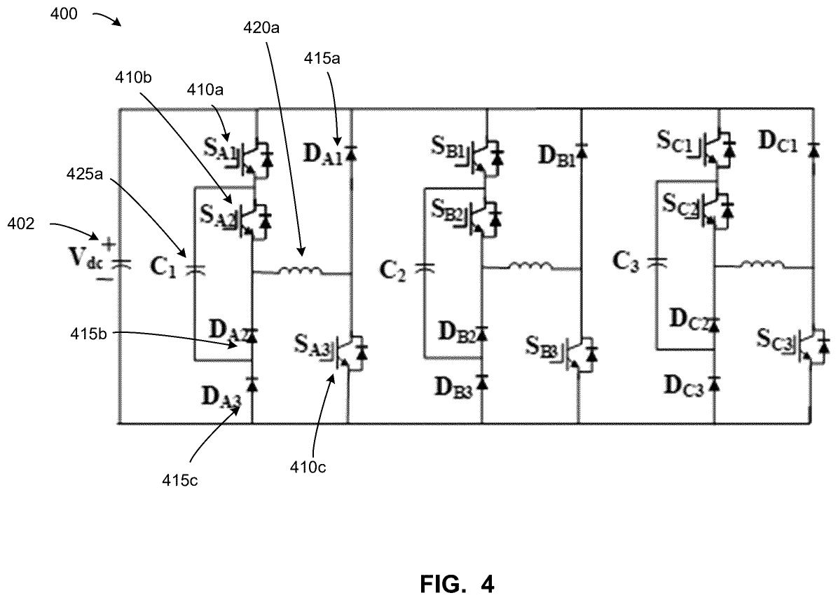

Multilevel converters have been investigated for low-voltage SRMs to provide flexible voltage selection under different operating regions. Compared to the two-level counterparts, multilevel converters offer several advantages including lower current and torque ripple, lower losses at high switching frequency, and lower electromagnetic interference (EMI). For low-voltage applications, such as electric/hybrid vehicles, asymmetric neutral point diode clamped (ANPC) multilevel converters (as discussed with reference to FIG. 3), asymmetric flying capacitor multilevel converters (as discussed with reference to FIG. 4), and other modified versions have been developed.

Reference is next made to FIG. 3, which illustrates an asymmetric neutral point diode clamped (ANPC) multilevel converter 300 for SRM drives, in accordance with an example embodiment. In the illustrated embodiment, the ANPC converter 300 includes a plurality of switches, diodes and inductors that are interconnected to form three phase legs. Each phase leg is configured in parallel to each of the other phase legs, a DC voltage source (not shown) and a series combination of a first capacitor 325a and a second capacitor 325b.

Further, as illustrated, each phase leg includes four switches, namely a first switch 310a, a second switch 310b, a third switch 310c and a fourth switch 310d, four diodes, namely a first diode 315a, a second diode 315b, a third diode 315c and a fourth diode 315d, and a phase inductive element 320a representing the corresponding phase winding. In this topology, three-level voltages are generated by splitting the dc-link using two capacitor banks. Further, the neutral point voltage is balanced by selecting the switching signals according to the measured voltage of the neutral point.

Reference is next made to FIG. 4, which illustrates an asymmetric flying capacitor (FC) multilevel converter 400 for SRM drives, in accordance with an example embodiment. In the illustrated embodiment, the asymmetric flying capacitor multilevel converter 400 includes a plurality of switches, diodes and inductors that are interconnected to form three phase legs. Each phase leg is configured in parallel to each of the other phase legs and a DC voltage source 402.

Further, as illustrated, each phase leg includes three switches, namely a first switch 410a, a second switch 410b and a third switch 410c, three diodes, namely a first diode 415a, a second diode 415b and a third diode 415c and a phase capacitor 425a. Inductive element 420a represents the corresponding phase winding.

Recent developments in two-level and multilevel converter topologies for switched reluctance motor (SRM) drives have been analyzed and compared in the literature. Multilevel approaches, such as five-level ANPC converters and modular multilevel converters (MMC), can offer performance benefits at high power and high speed, but they introduce significant practical challenges. For example, in a five-level ANPC converter, maintaining voltage balance across multiple capacitors can be difficult, and the increased number of semiconductor switches and clamping diodes adds cost and system complexity to the SRM drives. Similarly, MMC-based implementations can contain numerous capacitors, such as a five-level MMC topology contains 24 capacitors, that need pre-charging circuits and also need to be balanced, making such architecture unsuitable for low-voltage SRM applications.

Several voltage boosting schemes by adding a boosting capacitor to the standard AHB converter have also been considered in the literature. The boosted voltage is helpful at high-speed operation to inject current into phase winding when the amplitude of the induced voltage becomes higher than the dc-link voltage. However, the boosting circuits increase the ratings of the converter and also face overcharging or undesired charging problems of the boosting capacitor. A decentralized battery management topology has been considered in literature, where a half-bridge converter is connected to each battery cell to achieve independent battery charging and battery fault-tolerance. The topology can be used as a multilevel converter when cascaded with an AHB or full-bridge converter. However, this topology greatly increases cost, size and implementation complexity of the drive system. In some cases, an asymmetric three-level FC converter has been introduced which has the problem of balancing the flying capacitor in each phase-leg.

A comparative evaluation of three-level active ANPC converters and standard two-level AHB converters has been reported in the context of low-voltage applications, including electric vehicle drives, with considerations such as torque ripple, efficiency, and cost. In general, existing multilevel converter topologies can improve performance in low-voltage SRM drives, but they typically require substantially more components than the two-level AHB converter. For example, the ANPC topology introduces additional switches and clamping diodes to achieve multilevel voltage generation, while flying-capacitor converters require a dedicated capacitor and voltage sensor in each phase leg, which increases overall cost, physical size, and drive system complexity. Voltage-boosting circuits can support high-speed operation but also necessitate higher device voltage ratings, limiting their practicality.

To address these limitations, the present invention discloses a family of new multilevel converter topologies for SRM drives that successfully meet optimization objectives, such as, reduced component count, lower cost, compact size, simplified control and/or improved efficiency, while providing multilevel voltage generation flexibility.

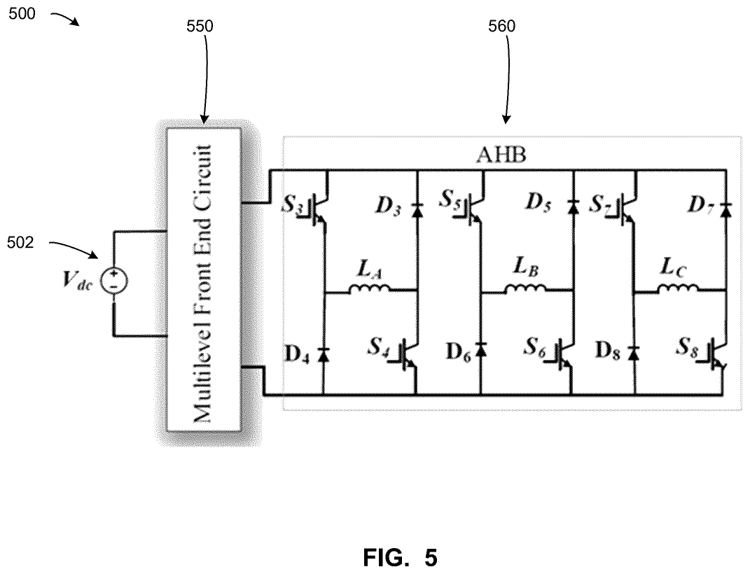

Reference is made to FIG. 5, which shows a schematic diagram of a universal multilevel voltage generation circuit 500 for SRM drives, in accordance with an example embodiment. As illustrated, circuit 500 includes a front-end circuit 550 coupled between a DC voltage source 502 and a back-circuit 560. In the illustrated embodiment, the back-circuit is a standard two-level AHB converter.

As shown, a phase leg circuit corresponding to a respective phase winding of the SRM is a combination of the front-end circuit 550 and a part of the back-end circuit. In other words, the front-end circuit 550 is common to all the phase leg circuits. Selective operation and control of the front-end circuit 550 together with the switching elements and diodes of the back-end circuit enables generation of multiple voltage levels and, accordingly, selective energization of the excitation coils of the corresponding phase windings.

### Three-level Simplified Asymmetric Neutral Point Diode Clamped Converter Topology

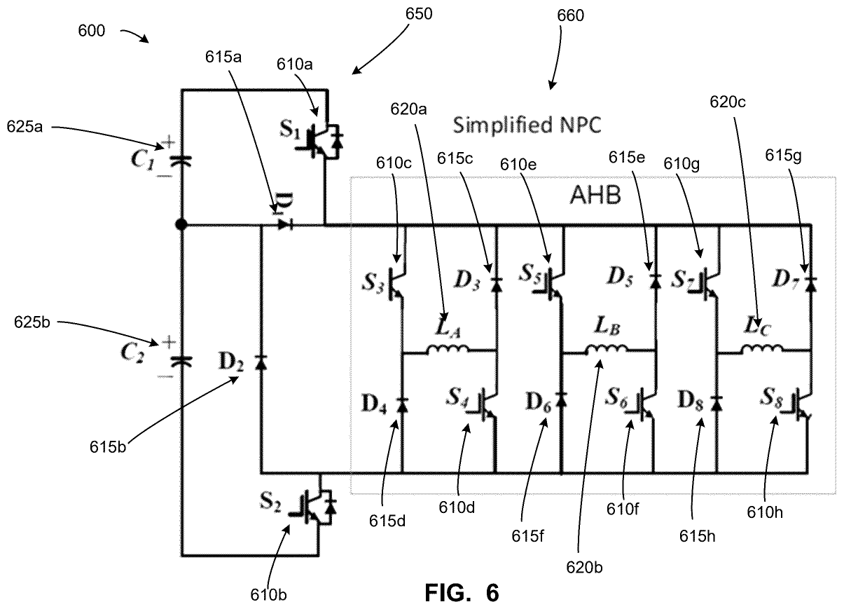

Reference is next made to FIG. 6, which illustrates a schematic diagram of an improved three-level ANPC converter topology 600 in accordance with an example embodiment. Topology 600 represents an optimized version of topology 300 shown in FIG. 3, achieving similar three-level voltage generation while using a reduced number of components and a simplified circuit configuration.

In the illustrated embodiment, the front-end circuit 650 of topology 600 contains two switches, namely a first switch 610a and a second switch 610b, and two diodes, namely a first diode 615a and a second diode 615b. The front-end circuit 650 further includes a first capacitor 625a and a second capacitor 625b.

Topology 600 further includes a standard AHB converter 660 coupled to the front-end circuit 650. The standard AHB converter 660 includes a plurality of switches, diodes and inductors that are interconnected to form three asymmetric half-bridge phase legs, each corresponding to one phase of the SRM. Each phase leg of the AHB converter 660 comprises two switches and two diodes. For example, the first phase leg comprises a third switch 610c and a fourth switch 610d, a third diode 615c and a fourth diode 615d. Inductive element 620a represents the corresponding phase winding. The second phase leg comprises a fifth switch 610e and a sixth switch 610f, a fifth diode 615e and a sixth diode 615f. Inductive element 620b represents the corresponding phase winding. Similarly, third phase leg comprises a seventh switch 610g and an eighth switch 610h, a seventh diode 615g and an eighth diode 615h. Inductive element 620c represents the corresponding phase winding.

The resulting topology 600 forms a three-level asymmetric neutral point diode clamped converter topology. Each phase leg of the resulting topology 600 comprises four switches (two from the common front-end circuit 650 and two from the standard AHB converter 660) and four diodes (two from the common front-end circuit 650 and two from the standard AHB converter 660). As shown, each phase leg sub-circuit is coupled in parallel to each of the DC voltage source (not shown) and other phase leg sub-circuits.

Table I shows an example switching table for the converter topology 600 of FIG. 6 for one phase leg (e.g., Phase A).

TABLE I
SWITCHING STATES S-ANPC CONSIDERING
PHASE A AS AN EXAMPLE

| Mode | | | | | Output | |
|---|---|---|---|---|---|---|
| No | S1 | S2 | S3 | S4 | voltage | Uₙ |
| 1 | 1 | 1 | 1 | 1 | Vc1 + Vc2 = V_{dc} | No change |
| 2 | 1 | 0 | 1 | 1 | Vc2 = 0.5 V_{dc} | Increase |
| 3 | 0 | 1 | 1 | 1 | Vc1 = 0.5 V_{dc} | Decrease |
| 4 | 1 | 1 | 0 | 1 | 0 | No change |
| 5 | 1 | 1 | 0 | 0 | −Vc1 − Vc2 = −V_{dc} | No change |

As shown in Table I, in switching mode 1, the phase winding for phase A is magnetized with input voltage, V_{dc}, when the first switch 610a (S1), second switch 610b (S2), third switch 610c (S3) and fourth switch 610d (S4) are all turned on simultaneously. In switching modes 2 and 3, when either the first switch 610a (S1) or the second switch 610b (S2) is turned off, the phase winding for phase A is magnetized with half of the input voltage, i.e. ½ V_{dc}. In switching mode 4, when the current controller turns off the upper switch of the phase leg, i.e., the third switch 610c (S3) for phase A, the phase turns into freewheeling mode. In switching mode 5, when both the upper and lower switches, i.e. the third switch 610c (S3) and the fourth switch 610d (S4), of phase A of the AHB converter 660 are turned off, the respective phase is demagnetized.

For capacitor voltage balancing, switching modes 2 and 3 from Table 1 are adopted based on the amplitude of the measured neutral point voltage, Uₙ. If the measured neutral point voltage, Uₙ, is higher than half of the input voltage, i.e. ½ V_{dc}, switching mode 3 is selected to reduce the neutral point voltage. On the other hand, if the measured voltage Uₙ is larger than half of the input voltage, i.e. ½ V_{dc}, switching mode 2 is selected to increase the voltage Uₙ.

### Three-Level Simplified Asymmetric Flying Capacitor Converter

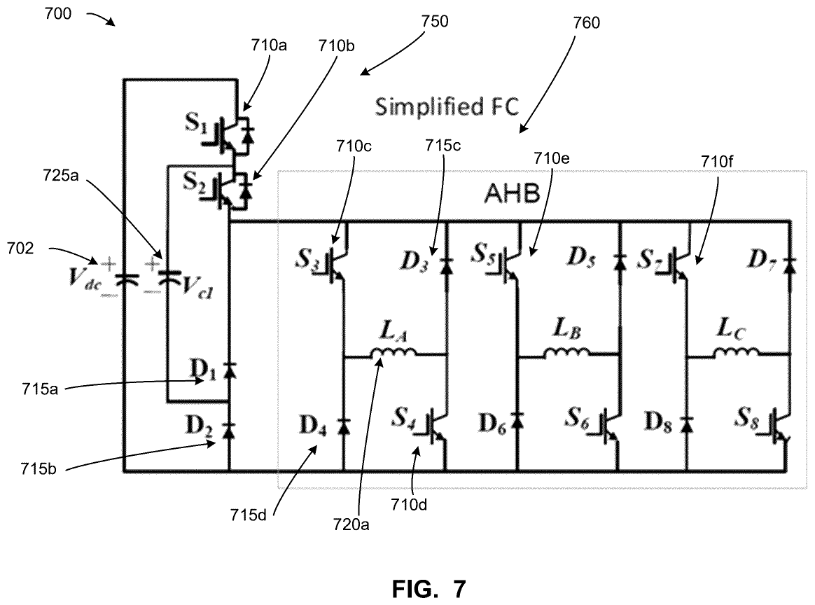

Reference is next made to FIG. 7, which illustrates a schematic diagram of an improved three-level asymmetric flying capacitor converter topology 700 in accordance with an example embodiment. Topology 700 represents an optimized version of topology 400 shown in FIG. 4. The conventional asymmetric flying capacitor three-level converter, such as that illustrated in FIG. 4, generates Vdc, and ½ Vdc by installing a capacitor bank in each phase leg of the SRM drive system. A single phase of such conventional converter constitutes of three power switches 410a-410c, three diodes 415a-415c and a capacitor 425a, as shown in FIG. 4. In contrast, topology 700, while simplified compared to topology 400, provides similar performance capability to topology 400.

In the illustrated embodiment, the front-end circuit 750 of topology 700 contains two switches, namely a first switch 710a and a second switch 710b, two diodes, namely a first diode 715a and a second diode 715b, and a capacitor, namely a first capacitor 725a. The front-end circuit 750 is further cascaded with a standard AHB converter 760. The standard AHB converter 660 includes a plurality of switches, diodes and inductors that are interconnected to form three asymmetric half-bridge phase legs, each corresponding to one phase of the SRM. Each phase leg of the AHB converter 660 comprises two switches and two diodes. For example, the first phase leg comprises a third switch 710c and a fourth switch 710d, a third diode 715c and a fourth diode 715d. Inductive element 720a represents the corresponding phase winding.

The resulting topology 700 forms a three-level asymmetric flying capacitor converter topology. Each phase leg of the resulting topology 700 comprises four switches (two from the common front-end circuit 750 and two from the standard AHB converter 760) and four diodes (two from the common front-end circuit 750 and two from the standard AHB converter 760). As shown, each phase leg sub-circuit is coupled in parallel to each of the DC voltage source (not shown) and other phase leg sub-circuits.

Table II shows an example switching table for the converter topology 700 of FIG. 7 for one phase leg (e.g., Phase A).

TABLE II
SWITCHING STATES S-FC CONSIDERING
PHASE A AS AN EXAMPLE

| Mode | | | | | | Output | |
|---|---|---|---|---|---|---|---|
| No. | S1 | S2 | S3 | S4 | S5/S7 | voltage | C1 |
| 1 | 1 | 1 | 1 | 1 | x | V_{dc} | No change |
| 2 | 1 | 0 | 1 | 1 | x | Vc2 = 0.5 V_{dc} | Charging |
| 3 | 0 | 1 | 1 | 1 | x | Vc1 = 0.5 V_{dc} | Discharging |
| 4 | 1 | 1 | 0 | 1 | x | 0 | No change |
| 5 | 1 | 1 | 0 | 0 | 0 | −Vc1 − Vc2 = −V_{dc} | No change |
| 6 | 1 | 1 | 0 | 0 | 1 | −0.5 V_{dc} | Charging |

As shown in Table II, there are six operating modes for converter 700. In table II, “x” represents a don't care state. In switching mode 1, the phase winding for phase A is magnetized with input voltage, V_{dc}, when the first switch 710a (S1), second switch 710b (S2), third switch 710c (S3) and fourth switch 710d (S4) are all turned on simultaneously. In other words, V_{dc} will be applied across the phase winding 720a (L_{A}). In switching modes 2 and 3, when either the first switch 710a (S1) or the second switch 710b (S2) is turned off, the phase winding for phase A is magnetized with half of the input voltage, i.e. ½ V_{dc}.

In switching mode 4, when the current controller turns off the upper switch of the phase leg, i.e., the third switch 710c (S3) for phase A, the phase turns into freewheeling mode. In switching mode 5, when both the upper and lower switches, i.e. the third switch 710c (S3) and the fourth switch 710d (S4), of phase A of the AHB converter 760 are turned off, and the upper switch (S5 and S7) 710e and 710f of the other phases are turned off, phase A is demagnetized. Similarly, in switching mode 6, when both the upper and lower switches, i.e. the third switch 710c (S3) and the fourth switch 710d (S4), of phase A of the AHB converter 760 are turned off, and the upper switch (S5 and S7) 710e and 710f of the other phases are turned on, phase A is partially demagnetized.

When the incoming phase is magnetized with ½ V_{dc} by turning off the second switch 710b (S2), the demagetization in the outgoing phase can be achieved by chopping the output voltage between modes 5 and 6. If the incoming phase is magnetizing with modes 2 or 3, the outgoing phase will be demagnetized with mode 6. However, if the incoming phase is in freehweeling mode, (i.e., mode 4), the outgoing phase will be demagnetized with mode 5 under −V_{dc}. The voltage of the capacitor 725a (C1) can be controlled by using the switching modes 2, 3 and 6 in Table II. When phase A is demagnetizing and phase B C is magnetizing, −½ V_{dc} is applied across the inductor 720a (L_{A}). In this way, independent operation of phases is achieved despite sharing the front-end circuit 750.

### Three-Level Modular Power Converter Topology

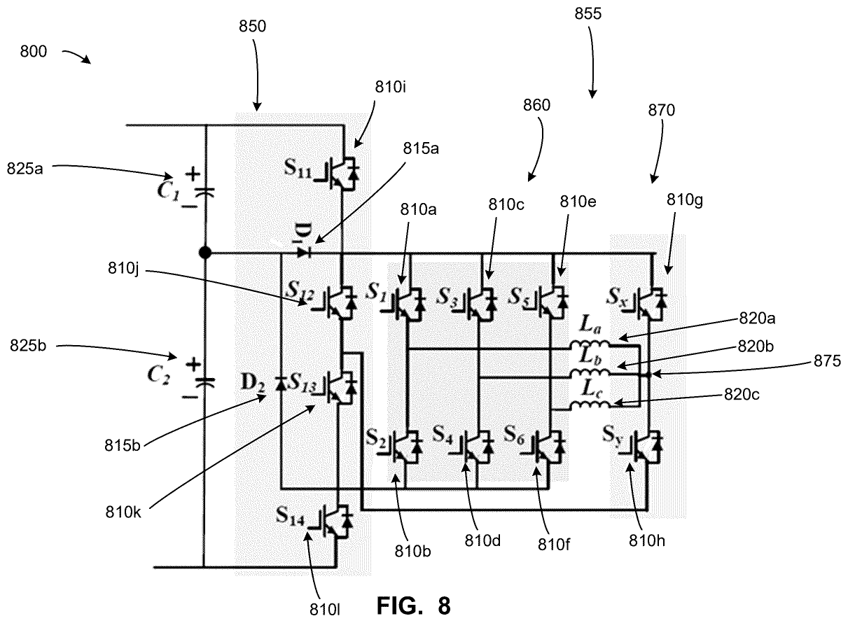

Reference is next made to FIG. 8, which illustrates a schematic diagram of a modular three-level topology 800 for SRM drives in accordance with an example embodiment.

Topology 800 generates three voltage levels using NPC front-end 850 coupled to circuit 855, which comprises a six-pack power switch module 860 with a half-bridge 870 connected to the neutral point 875. Front-end 850 includes four switches, namely a first switch 810i, a second switch 810j, a third switch 810k and a fourth switch 810l, two diodes, including a first diode 815a and a second diode 815b, and two capacitors, including a first capacitor 825a and a second capacitor 825b.

Circuit 860 of topology 800 includes a six-pack power switch module, including a first switch 810a, a second switch 810b, a third switch 810c, a fourth switch 810d, a fifth switch 810e and a sixth switch 810f. Half-bridge circuit 870 includes a seventh switch 810g and an eighth switch 810h. Inductive element 820a represents the first phase winding (phase A), inductive element 820b represents the second phase winding (phase B) and inductive element 820c represents the third phase winding (phase C).

In the illustrated embodiment, various switches 810a-810l of topology 800 can consist of insulated-gate bipolar transistor (IGBT) transistors offering wide range of applications.

Table III shows an example switching table for the converter topology 800 of FIG. 8 for one phase leg (e.g., Phase A).

TABLE III
SWITCHING STATES S-FC CONSIDERING PHASE A AS AN EXAMPLE

| | | | | | | | | | | | | | | | Neutral |
|---|---|---|---|---|---|---|---|---|---|---|---|---|---|---|---|
| Mode | | | | | | | | | | | | | Output | | point |
| No. | S11 | S12 | S13 | S14 | S1 | S2 | S3 | S4 | S5 | S6 | Sx | Sy | voltage | | voltage |
| 1 | 1 | 0 | 0 | 1 | 1 | 0 | 0 | 0 | 0 | 0 | 0 | 1 | V_{dc} | | No change |
| 2 | 0 | 0 | 0 | 1 | 1 | 0 | 0 | 0 | 0 | 0 | 0 | 1 | 0.5 | V_{dc} | increase |
| 3 | 1 | 1 | 0 | 0 | 0 | 1 | 0 | 0 | 0 | 0 | 0 | 1 | 0.5 | V_{dc} | Decrease |
| 4 | 0 | 0 | 0 | 0 | 1 | 0 | 0 | 0 | 0 | 0 | 0 | 0 | 0 | | No change |
| 5 | 0 | 0 | 0 | 0 | 0 | 0 | 0 | 0 | 0 | 0 | 0 | 0 | −−V_{dc} | | No change |
| 6 | 0 | 1 | 1 | 0 | 0 | 0 | 0 | 0 | 0 | 0 | 0 | 0 | −0.5 | V_{dc} | Decrease |

Table III illustrates that the SRM drive of FIG. 8 can achieve independent phase current control. The critical case is to have magnetization in one phase and demagnetization in the adjacent phase which is achieved through the switching modes 1 and 5. In switching mode 1, the first and the fourth switches 810i and 810l of the front-end circuit 850 are closed and the second and the third switches 810j and 810k are open. Further, the first switch 810a and the eighth switch 810h are closed and the remaining switches are open. In this mode, the output voltage is equal to the input voltage, V_{dc}. In switching mode 5, all the switches 810a-810l are open. In addition, switching modes 2, 3 and 6 can be used to balance the neutral point voltage.

Topology 800 provides several technical advantages. For example, the converter 800 can be constructed using commercially available half-bridge and six-pack power switch modules, facilitating straightforward implementation and reducing design complexity. Its modular structure significantly reduces the overall system cost and size while supporting scalability across a broader range of drive applications. In addition, the availability of three-level output voltages enhances the performance of the SRM drive by contributing to reduced noise and decreased torque ripple.

### A Flexible Multilevel Fault-Tolerant Converter Topology

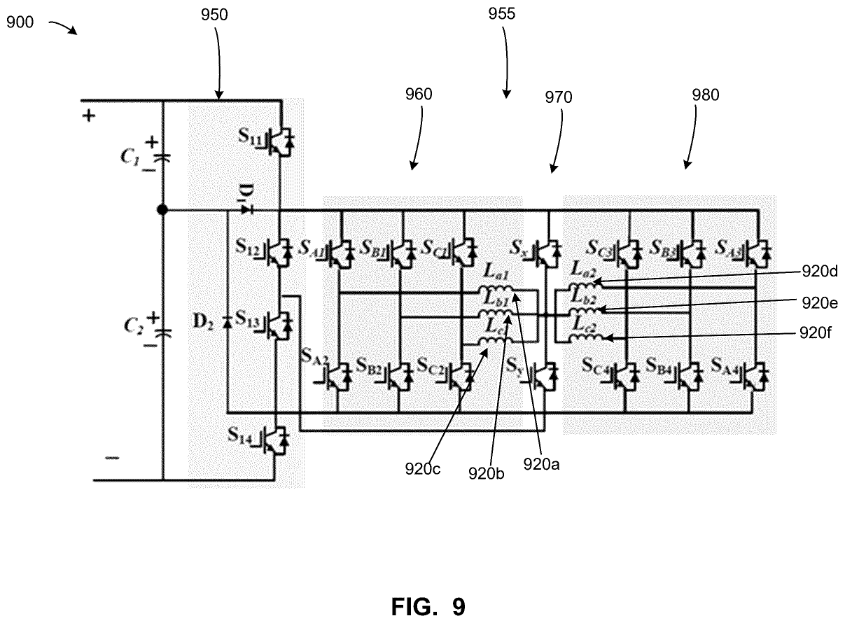

Reference is next made to FIG. 9, which illustrates a flexible multilevel fault-tolerant converter topology 900 in accordance with an example embodiment. Topology 900 generates multiple voltage levels using an NPC front-end 950 coupled with a reconfigurable circuit 960. The topology 900 enables online reconfiguration of the winding connections between series and parallel modes. During low-speed operation, the series winding configuration is employed to provide high average torque, whereas at high-speed operation, the parallel winding configuration is selected to extend the operational speed range by weakening the flux linkage.

In conventional SRMs, as the rotational speed increases, the corresponding rotating back electromotive force (EMF) component also increases. At sufficiently high speeds, the dc-link voltage becomes insufficient for current regulation, and the SRM drive operates in single-pulse control (SPC). As a result, the rotor speed becomes limited and cannot be increased further. The topology 900 of FIG. 9 overcomes this limitation by enabling a reduction of the effective phase inductance through online reconfiguration of the winding connections, thereby extending the achievable speed range.

As illustrated in FIG. 9, there are four parts in this converter topology, including the front-end NPC leg 950 coupled to a circuit 955, which includes a first six-pack module 960 with first half of the winding, a half-bridge for series parallel reconfigurations 970 and the second half of the winding with the second six-pack module 980. Circuits 960 and 970 are analogous to circuits 860 and 870 of FIG. 8. Circuit 980 is analogous to circuit 960 and circuit 860 of FIG. 8.

Inductive element 920a represents the first half of the first phase winding (phase A), inductive element 920b represents the first half of the second phase winding (phase B) and inductive element 920c represents the first half of the third phase winding (phase C). Inductive element 920d represents the second half of the first phase winding (phase A), inductive element 920e represents the second half of the second phase winding (phase B) and inductive element 920f represents the second half of the third phase winding (phase C).

Topology 900 provides fault-tolerant capabilities. If one of the parts is in faulty condition, the converter 900 can still work normally without performance degradation. For example, if all the switches in the first six-pack module 960 or second six-pack module 980 are open-circuited, the converter topology reconfigures itself to FIG. 9 with no negative influence on the drive system. Similarly, if the NPC front-end leg 950 is faulty, the converter 900 transforms to a two-level converter topology. The SRM drive will operate normally if two parts are broken, and two parts are healthy.

Table IV shows an example switching table for the converter topology 900 of FIG. 9 for one phase leg (e.g., Phase A). In particular, the series and parallel winding switching modes are shown in Table IV below.

TABLE IV
MAGNETIZATION MODES UNDER SERIES AND PARALLEL CONNECTIONS

| | | | | | | | | | | | | Neutral | |
|---|---|---|---|---|---|---|---|---|---|---|---|---|---|
| Mode | | | | | | | | | | | Output | point | |
| No. | S11 | S12 | S13 | S14 | SA1 | SA2 | SA3 | SA4 | Sx | Sy | voltage | voltage | Connection |
| 1 | 1 | 0 | 0 | 1 | 1 | 0 | 0 | 1 | 0 | 0 | V_{dc} | No change | Series |
| 2 | 0 | 0 | 1 | 1 | 1 | 0 | 0 | 1 | 0 | 0 | 0.5 V_{dc} | increase | Series |
| 3 | 1 | 0 | 1 | 0 | 1 | 0 | 0 | 1 | 0 | 0 | 0.5 V_{dc} | Decrease | Series |
| 4 | 1 | 0 | 0 | 1 | 1 | 0 | 1 | 0 | 0 | 1 | V_{dc} | No change | Parallel |
| 5 | 0 | 0 | 1 | 1 | 1 | 0 | 1 | 0 | 0 | 1 | 0.5 V_{dc} | increase | Parallel |
| 6 | 1 | 0 | 1 | 0 | 1 | 0 | 0 | 1 | 0 | 0 | 0.5 V_{dc} | Decrease | Parallel |
| 7 | 1 | 0 | 0 | 1 | 0 | 1 | 0 | 1 | 1 | 0 | V_{dc} | No change | Parallel |
| 8 | 0 | 0 | 1 | 1 | 0 | 1 | 0 | 1 | 1 | 0 | 0.5 V_{dc} | increase | Parallel |
| 9 | 1 | 0 | 1 | 0 | 0 | 1 | 0 | 1 | 1 | 0 | 0.5 V_{dc} | Decrease | Parallel |

As shown in Table IV, there are nine operating modes for converter 900. Switching modes 1, 2 and 3 result in series configuration, and switching modes 4-9 result in parallel configuration of the converte 900. As seen in Table IV, there are flexible voltage selection options with this topology under both series and parallel connection modes. By using the switches Sx and Sy of the half-bridge circuit 970, the winding connection can easily be reconfigured online.

Topology 900 provides various advantages, such as, for example, converter 900 can achieve high speed operation with real-time series-parallel connections. Further, the performance of the SRM drive is significantly improved due to the multilevel voltage selection opportunity at the low-speed operation and the parallel winding connection at high-speed operation. In addition, as discussed above, converter 900 offers extreme fault tolerance capabilities, which makes it suitable for applications, such as, electric aircraft applications.

### Boosting Voltage Configuration

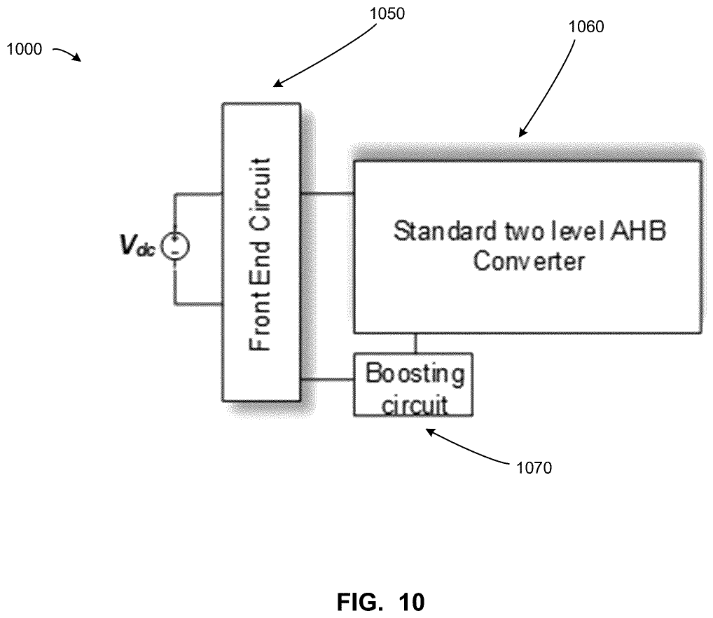

Reference is next made to FIG. 10, which illustrates a schematic diagram of an improved SRM drive circuit with boosting topology 1000, in accordance with an example embodiment. Topology 1000 comprises a front-end circuit 1050 coupled to a standard two-level AHB converter 1060. Topology 1000 further comprises a voltage boosting circuit 1070 coupled to the front-end circuit 1050 and the two-level AHB converter 1060.

Typically, in SRM drives at high-speed operation, such as, for example, operation above the base speed, the induced voltage becomes higher than the available dc-link voltage. In such a situation, the dc-link voltage becomes insufficient to inject current into the phase to maintain a constant torque. Moreover, the demagnetization tail current takes longer time to decay generating a negative in the inductance descending region.

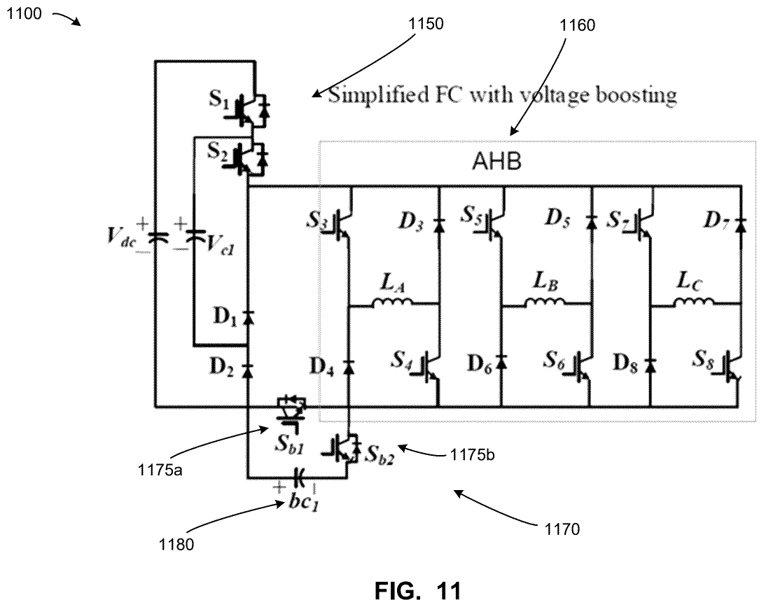

The boosting circuit, such as circuit 1070 of FIG. 10, addresses this deficiency of conventional SRM drives by including a boosting capacitor (as discussed in detail below). Although reference is next made to FIG. 11, which illustrates one example of a boosting circuit, the boosting circuit 1070 can be integration with all the topologies discussed with reference to FIGS. 5-9.

Reference is now made to FIG. 11, which illustrates a schematic diagram of an improved three-level asymmetric flying capacitor converter with boosting circuit topology 1100 in accordance with an example embodiment. Topology 1100 is analogous to topology 700 of FIG. 7, with the addition of a boosting circuit 1170. The front-end 1150 is analogous to front-end 750 and the AHB circuit 1160 is analogous to AHB circuit 760.

The boosting circuit 1170 includes a first boosting switch 1175a (S_{b1}), a second boosting switch 1175b (S_{b2}) and a boosting capacitor 1180 (bc₁).

The boosting capacitor 1180 is employed to enable rapid magnetization and demagnetization of the SRM phases in high-speed operating regions, thereby enhancing current control where conventional dc-link voltages may be insufficient. Unlike conventional implementations where a boosting capacitor is continuously active to achieve fast magnetization and demagnetization under all operating regions, in the topologies disclosed herein, the boosting capacitor 1180 is engaged selectively only under high-speed conditions. At lower speeds or lower power ratings, boosting capacitor 1180 remains inactive, avoiding unnecessary current ripple and acoustic noise. The controlled charging and discharging of the boosting capacitor 1180 is achieved through the coordinated operation of the first boosting switch 1175a and the second boosting switch 1175b. During low-speed operation, the boosting capacitor 1180 is effectively bypassed by keeping the first boosting switch 1175a continuously on while the second boosting switch 1175b is turned off, such that the switching modes correspond to those described in Table II and topology 700 of FIG. 7. In contrast, during high-speed operation, the first boosting switch 1175a is selectively charged and discharged to provide an adaptive voltage boost. The corresponding switching modes are summarized in Table V.

TABLE V
SWITCHING STATES AT HIGH SPEED OPERATION

| Mode | | | | | | | Output | | |
|---|---|---|---|---|---|---|---|---|---|
| No. | S1 | S2 | S3 | S4 | Sb₁ | Sb₂ | voltage | C1 | bc₁ |
| 1 | 1 | 1 | 1 | 1 | 0 | 1 | V_{dc} + | No | Discharging |
| | | | | | | | Vb_{c1} | change | |
| 2 | 1 | 1 | 0 | 1 | 0 | 1 | 0 | No | No Change |
| | | | | | | | | change | |
| 3 | 1 | 1 | 0 | 0 | 0 | 1 | 0 | No | Charging |
| | | | | | | | | change | |

Taking phase A as an example, topology 1100 has three operating modes at the high-speed regions near the rated speed. Phase A is magnetized and demagnetized under the summation voltage of the dc-link and the boosting capacitor 1180. This provides the advantage of achieving high average torque and increasing the output power of the SRM drive system. This boosting circuit has no effect at the low operating speed where half of the input voltage, i.e. ½ Vdc, is sufficient. Topology 1100 improves the performance of the drive system under wide operating regions from low to rated power rating regions.

### Simulations Validations

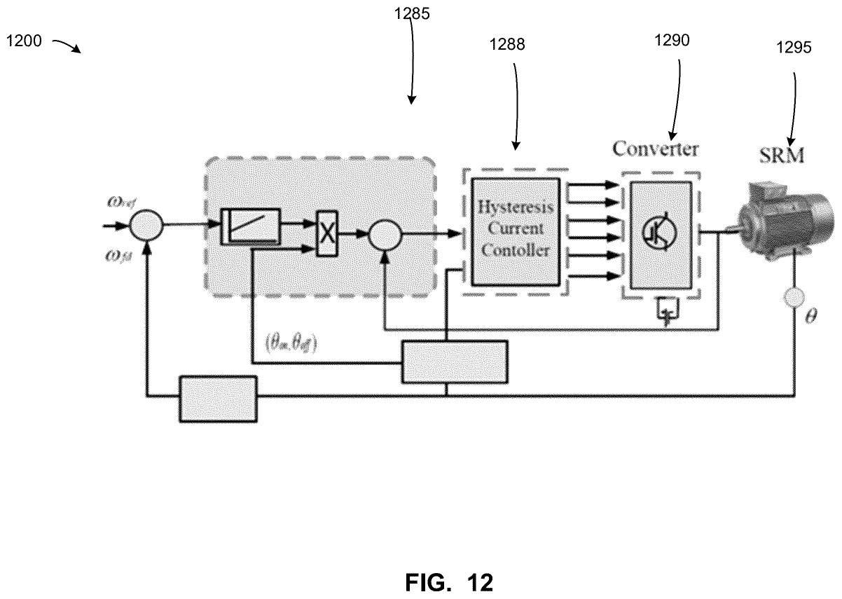

Reference is next made to FIG. 12, which illustrates a physical prototype 1200, in accordance with an example embodiment, for testing the various topologies disclosed herein. Prototype 1200 includes a 3-phase 12/8 SRM 1295, a SRM drive system 1290, and a current control system 1285 including a hysteresis current controller 1288. The current control system 1285 is a closed-loop system of the current chopping control (CCC) scheme. In the illustrated embodiment, the rated voltage, speed, power and torque are 48V, 3800 rpm, 400 W and 1 Nm, respectively. The SRM drive systems disclosed herein are independent of machine parameters and thus can be adopted for SRMs with any configuration. Controller 1288 is configured to generate a dual band hysteresis current control to simulate various three-level converter topologies under different operating regions.

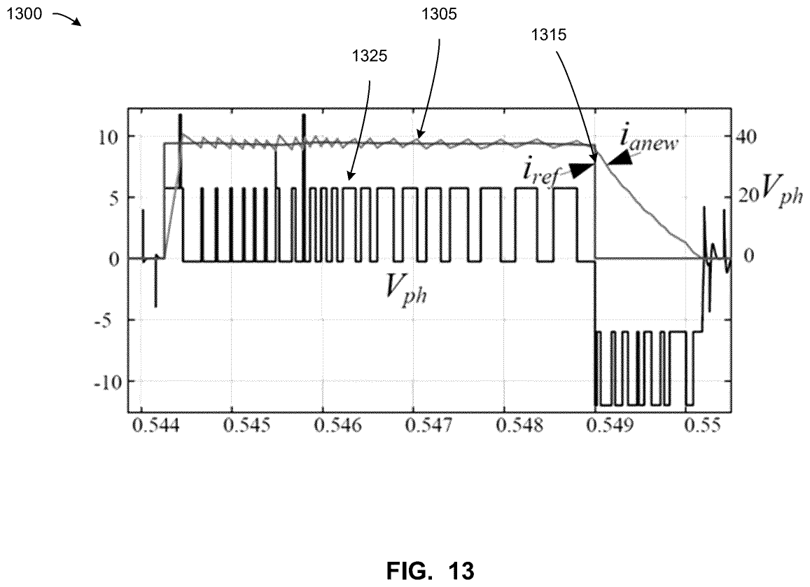

Reference is made to FIG. 13, which illustrates example simulation waveforms 1300 for a SANPC converter topology, such as topology 600 of FIG. 6, operating at approximately 500 rpm in accordance with an example embodiment. In particular, FIG. 13 shows a first waveform 1305 corresponding to a fundamental current of phase A, a second waveform 1315 corresponding to reference current, i_{ref} and a third waveform 1325 corresponding to the phase voltage in a fundamental period at 500 rpm. Waveforms 1300 demonstrate that a rapid increase in phase current is achieved when the full DC-link voltage, V_{dc}, is applied and the current is subsequently regulated using approximately half of the full DC-link voltage, ½ V_{dc}, during the phase turn-on interval.

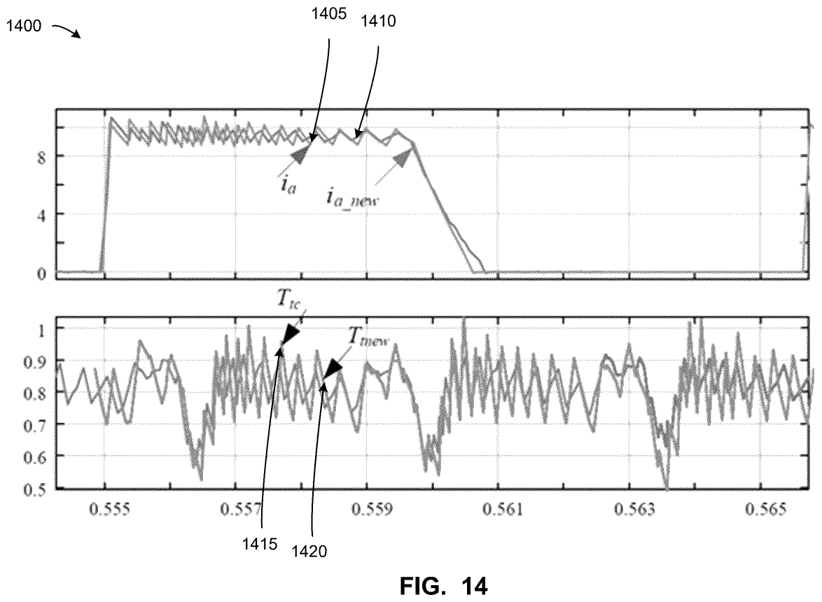

Reference is next made to FIG. 14, which illustrates example simulation waveforms 1400 comparing the current ripple and a torque ripple produced by an AHB converter and a SANPC topology, in accordance with an example embodiment. As shown in FIG. 14, the SANPC topology yields reduced current ripple 1410 compared to the current ripple 1405 resulting from a standard AHB converter. Similarly, the SANPC topology yields reduced torque ripple 1420 compared to the torque ripple 1415 resulting from a standard AHB converter.

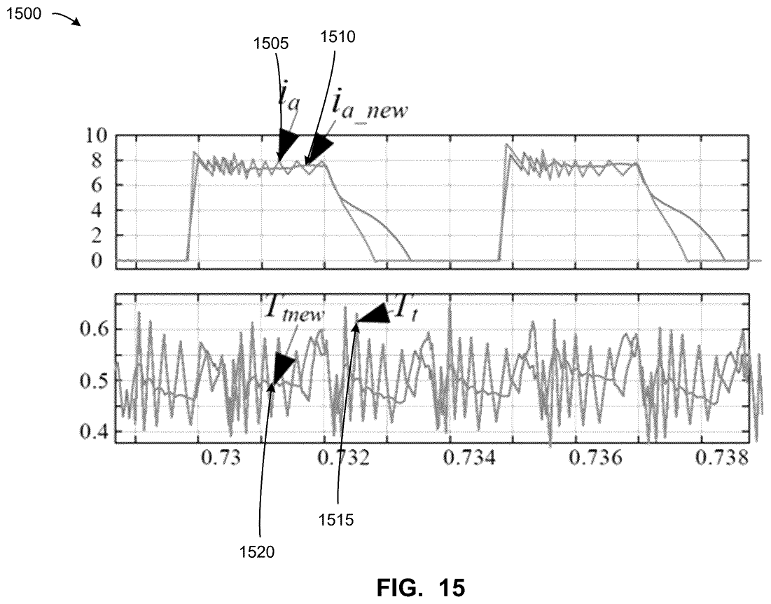

Reference is made to FIG. 15, which illustrates example simulation waveforms 1500 comparing the current ripple and a torque ripple produced by an AHB converter and a SFC topology at 1500 rpm, in accordance with an example embodiment. As shown in FIG. 15, the SFC topology yields significantly reduced current ripple 1510 compared to the current ripple 1505 resulting from a standard AHB converter. Similarly, the SFC topology yields significantly reduced torque ripple 1520 compared to the torque ripple 1515 resulting from a standard AHB converter. In fact, the ripples in both current and torque have been largely eliminated in the waveforms yielding from SFC topology simulation. The reduction in the current and torque ripple provides the advantage of reducing the noise in the SRM drive system.

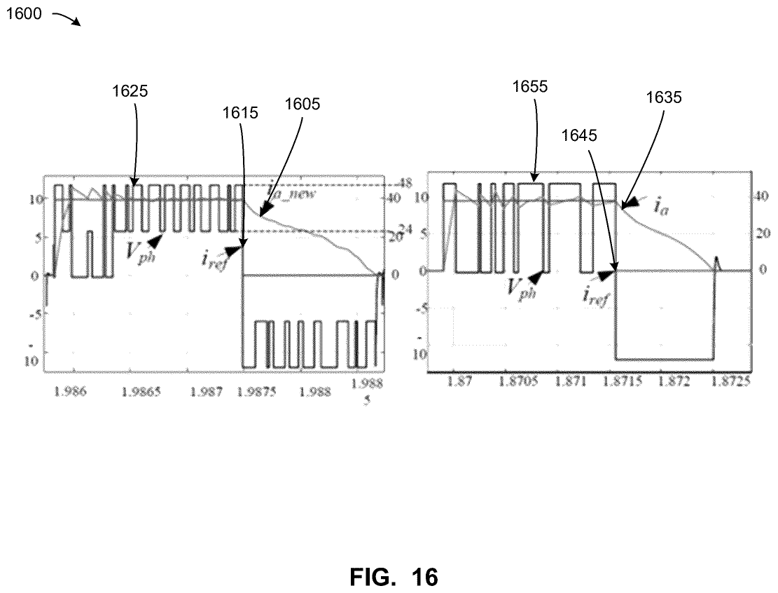

Reference is made to FIG. 16, which illustrates example simulation waveforms 1600 FIG. 16 is a graph showing a comparison of simulation tests with an AHB converter and SANPC topology at 2000 rpm, in accordance with an example. In particular, FIG. 16 shows a first waveform 1605 corresponding to a fundamental current of phase A, a second waveform 1615 corresponding to reference current, i_{ref} and a third waveform 1625 corresponding to the phase voltage in a fundamental period resulting from a simulation test with a SANPC converter at 2000 rpm. FIG. 16 also shows a waveform 1635 corresponding to a fundamental current of phase A, a waveform 1645 corresponding to reference current, i_{ref} and a waveform 1655 corresponding to the phase voltage in a fundamental period resulting from a simulation test with a conventional AHB converter at 2000 rpm. As seen in FIG. 16, the output voltage 1655 resulting from a standard two-level AHB converter is regulated between the dc-link voltage and zero, while the output voltage 1625 resulting from the SANPC converter is regulated between the V_{dc}, ½ V_{dc} and zero depending on the current error.

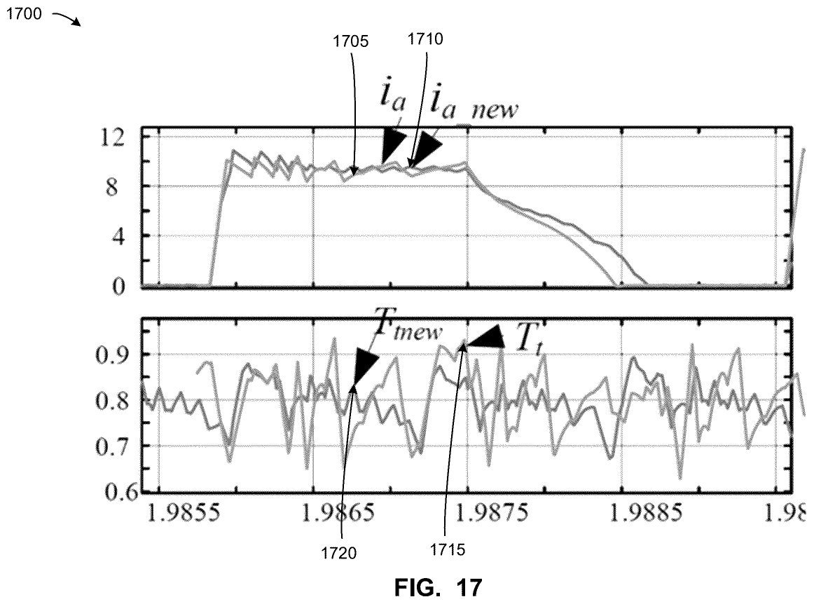

Reference is next made to FIG. 17, which illustrates example simulation waveforms 1700 comparing the current ripple and a torque ripple produced by an AHB converter and a SANPC topology at 2000 rpm, in accordance with an example embodiment. As shown in FIG. 17, the SANPC topology yields significantly reduced current ripple 1710 compared to the current ripple 1705 resulting from a standard AHB converter. Similarly, the SANPC topology yields significantly reduced torque ripple 1720 compared to the torque ripple 1715 resulting from a standard AHB converter.

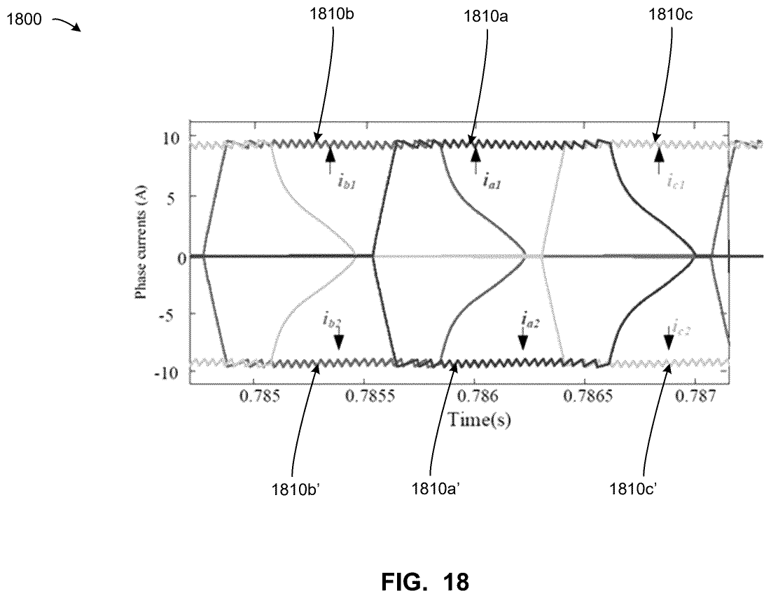

Reference is next made to FIG. 18, which illustrates example simulation waveforms 1800 showing three-phase current under parallel winding connection of a modular three-level topology shown, for example, in FIG. 9, in accordance with an example embodiment. FIG. 18 shows a positive current (iₐ₁) waveform 1810a present in the first half winding of Phase A and negative current (iₐ₂) 1810a′ present in the second half winding of phase A, both generated though the operating mode 7 shown in Table V. FIG. 18 additionally shows a positive current (i_{b1}) waveform 1810b present in the first half winding of Phase B and negative current (i_{b2}) 1810b′ present in the second half winding of phase B, and a positive current (i_{c1}) waveform 1810c present in the first half winding of Phase C and negative current (i_{c2}) 1810c′ present in the second half winding of phase C.

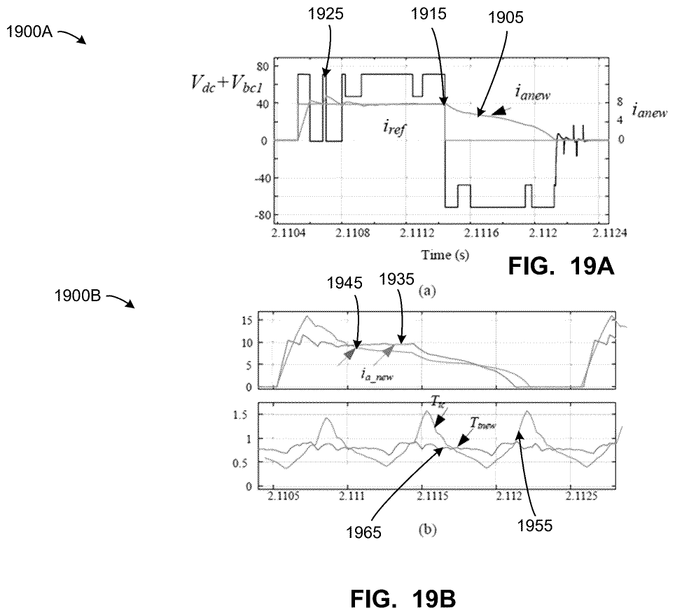

Reference is made to FIG. 19A, which illustrates example simulation waveforms 1900A for a three-level converter with voltage boosting topology for high-speed operation, in accordance with an example embodiment. In particular, FIG. 19 shows a first waveform 1905 corresponding to a fundamental current of phase A, a second waveform 1915 corresponding to reference current, i_{ref} and a third waveform 1925 corresponding to the phase voltage in a fundamental period. As shown by the voltage waveform 1925, the boosted voltage (V_{dc}+V_{bc1}) is applied across the phase winding which has significant impact on the torque ripple when compared to the AHB converter under the same operating conditions.

Reference is next made to FIG. 19B, which illustrates example simulation waveforms 1900B comparing the current ripple and a torque ripple produced by an AHB converter and a voltage boosting topology, in accordance with an example embodiment. As shown in FIG. 19B, the boosting voltage topology yields significantly reduced current ripple 1935 compared to the current ripple 1945 resulting from a standard AHB converter. Similarly, the voltage boosting topology yields significantly reduced torque ripple 1965 compared to the torque ripple 1955 resulting from a standard AHB converter.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

### CITATIONS

J. Ahn and G. F. Lukman, “Switched reluctance motor: Research trends and overview,” in CES Transactions on Electrical Machines and Systems, vol. 2, no. 4, pp. 339-347, December 2018, doi: 10.30941/CESTEMS.2018.00043.
E. Bostanci, M. Moallem, A. Parsapour and B. Fahimi, “Opportunities and challenges of switched reluctance motor drives for electric propulsion: A comparative study,” in IEEE Transactions on Transportation Electrification, vol. 3, no. 1, pp. 58-75, March 2017.
Krishnan R. Switched reluctance motor drives: modeling, simulation, analysis, design, and applications. CRC press; 2017 Dec. 19.
J. Rodriguez, “Multilevel inverters: A survey of topologies, controls, and applications,” IEEE Trans. Ind. Electron., vol. 49, no. 4, pp. 724-738, August 2002.
T. Lipo, “Improvements in EMC performance of inverter-fed motor drives,” IEEE Trans. Ind. Appl., vol. 31, no. 6, pp. 1247-1256, 1995.
M. A. Gaafar, A. Abdelmaksoud, M. Orabi, H. Chen and M. Dardeer, “Switched Reluctance Motor Converters for Electric Vehicles Applications: Comparative Review,” in IEEE Transactions on Transportation Electrification, 2022, doi: 10.1109/TTE.2022.3192429.
D. Patil, S. Wang and L. Gu, “Multilevel converter topologies for high-power high-speed switched reluctance motor: Performance comparison,” 2016 IEEE Applied Power Electronics Conference and Exposition (APEC), Long Beach, CA, USA, 2016, pp. 2889-2896, doi: 10.1109/APEC.2016.7468274.
Jianing Liang, Dong-Hee Lee, Guoqing Xu, and Jin-Woo Ahn, “Analysis of Passive Boost Power Converter for Three-Phase SR Drive,” IEEE Trans. Ind. Electron., vol. 57, no. 9, pp. 2961-2971 September 2010, doi: 10.1109/TIE.2010.2040558.
C. Peng, S. Song, R. Ma and W. Liu, “A novel modular 4-level power converter-based direct instantaneous torque control strategy for switched reluctance machine,” 2018 13th IEEE Conference on Industrial Electronics and Applications (ICIEA), Wuhan, China, 2018, pp. 2079-2083,
J. Liang, D. H. Lee, J. W. Ahn, “Direct instantaneous torque control of switched reluctance machines using 4-level converters,” IET Electric Power Applications, vol. 3, no. 4, pp. 313-323, 2009
C. Gan, Q. Sun, J. Wu, W. Kong, C. Shi and Y. Hu, “MMC-Based SRM Drives With Decentralized Battery Energy Storage System for Hybrid Electric Vehicles,” in IEEE Transactions on Power Electronics, vol. 34, no. 3, pp. 2608-2621 March 2019, doi: 10.1109/TPEL.2018.2846622.
S. J. Watkins, J. Corda and L. Zhang, “Multilevel asymmetric power converters for switched reluctance machines,” 2002 International Conference on Power Electronics, Machines and Drives, Sante Fe, pp. 195-200, June 2002.
F. Peng, J. Ye and A. Emadi, “An Asymmetric Three-Level Neutral Point Diode Clamped Converter for Switched Reluctance Motor Drives,” in IEEE Transactions on Power Electronics, vol. 32, no. 11, pp. 8618-8631 November 2017.

1. A multilevel converter system for driving a switched reluctance motor (SRM), the system comprising:
a front-end circuit coupled to a DC supply voltage, the front-end circuit comprising a respective plurality of switching elements and a plurality of diodes;
a back-end circuit coupled to the front-end circuit, the back-end circuit comprising a respective plurality of switching elements;
a plurality of phase leg circuits, each phase leg circuit corresponding to a respective phase winding of the SRM, each phase leg circuit comprising the front-end circuit entirely and a subset of the switching elements from the back-end circuit; and
a controller configured to selectively control the switching elements and diodes of the front-end circuit and of the subset of the back-end circuit forming each phase leg circuit to generate a plurality of selectable voltage levels for operating the SRM in a plurality of operating modes.

2. The converter system of claim 1, wherein:
the back-end circuit comprises an asymmetric half-bridge converter, wherein each subset of the back-end circuit comprises two switching elements and two diodes configured in an asymmetric half-bridge configuration, and
the front-end circuit comprises two switching elements and two diodes, and
the front-end circuit and the back-end circuit are configured together to form a simplified three-level asymmetric neutral point clamped (SANPC) converter topology, wherein each phase leg circuit comprises four switching elements and four diodes, and wherein the SRM is configured to generate three voltage levels.

3. The converter system of claim 2, wherein the plurality of selectable voltage levels are generated by splitting the DC supply voltage using two capacitor banks.

4. The converter system of claim 1, wherein:
the back-end circuit comprises an asymmetric half-bridge converter, wherein each subset of the back-end circuit comprises two switching elements and two diodes configured in an asymmetric half-bridge configuration, and
the front-end circuit comprises two switching elements and two diodes coupled to a capacitor bank,
the front-end circuit and the back-end circuit are configured together to form a three-level asymmetric flying capacitor converter (SFC) converter topology, wherein each phase leg circuit comprises four switching elements, four diodes and one capacitor bank, and wherein the SRM is configured to generate three voltage levels.

5. The converter system of claim 1, further comprising a boosting circuit coupled to the front-end circuit and the back-end circuit.

6. The converter system of claim 5, wherein the boosting circuit comprises two corresponding switching elements and a boosting capacitor bank, and wherein the controller is configured to selectively control the two corresponding switching elements of the boosting circuit to charge and discharge the boosting capacitor bank.

7. A converter system for driving a switched reluctance motor (SRM), the system comprising:
a front-end circuit comprising four switching elements and two diodes,
a back-end circuit comprising at least one module of six switching elements coupled to a half-bridge circuit connected to a neutral point, wherein the front-end circuit and the back-end circuit are configured together to form a modular multilevel converter topology, and
a controller configured to selectively control the front-end circuit and the back-end circuit to generate a plurality of selectable voltage levels for operating the SRM in a plurality of operating modes.

8. The converter system of claim 7, wherein the plurality of selectable voltage levels are generated by splitting the DC supply voltage using two capacitor banks.

9. The converter system of claim 8, wherein the SRM is configured to generate three voltage levels.

10. The converter system of claim 7, wherein the at least one module of six switching elements comprises two modules of six switching elements each, and wherein the controller is configured to selectively control the modular multilevel converter topology to generate reconfigurable series and parallel configurations.

11. The converter system of claim 7, further comprising a boosting circuit coupled to the front-end circuit and the back-end circuit.

12. The converter system of claim 11, wherein the boosting circuit comprises two corresponding switching elements and a boosting capacitor bank, and wherein the controller is configured to selectively control the two corresponding switching elements of the boosting circuit to charge and discharge the boosting capacitor bank.

13. A method of generating multilevel voltages for switched reluctance motor (SRM) drives using a multilevel converter system, wherein the system comprises:
a front-end circuit coupled to a DC supply voltage, the front-end circuit comprising a respective plurality of switching elements and a plurality of diodes;
a back-end circuit coupled to the front-end circuit, the back-end circuit comprising a respective plurality of switching elements;
a plurality of phase leg circuits, each phase leg circuit corresponding to a respective phase winding of the SRM, each phase leg circuit comprising the front-end circuit entirely and a subset of the switching elements from the back-end circuit; and
a controller coupled to the front-end circuit and the back-end circuit,
wherein the method comprises:
selectively controlling, using the controller, the switching elements and diodes of the front-end circuit and of the subset of the back-end circuit forming each phase leg circuit; and
generating a plurality of selectable voltage levels for operating the SRM in a plurality of operating modes.

14. The method of claim 13, wherein:
the back-end circuit comprises an asymmetric half-bridge converter, wherein each subset of the back-end circuit comprises two switching elements and two diodes configured in an asymmetric half-bridge configuration, and
the front-end circuit comprises two switching elements and two diodes, and
the front-end circuit and the back-end circuit are configured together to form a simplified three-level asymmetric neutral point clamped (SANPC) converter topology, wherein each phase leg circuit comprises four switching elements and four diodes, and wherein the SRM is configured to generate three voltage levels.

15. The method of claim 14, wherein the plurality of selectable voltage levels are generated by splitting the DC supply voltage using two capacitor banks.

16. The method of claim 13, wherein:
the back-end circuit comprises an asymmetric half-bridge converter, wherein each subset of the back-end circuit comprises two switching elements and two diodes configured in an asymmetric half-bridge configuration, and
the front-end circuit comprises two switching elements and two diodes coupled to a capacitor bank,
the front-end circuit and the back-end circuit are configured together to form a three-level asymmetric flying capacitor converter (SFC) converter topology, wherein each phase leg circuit comprises four switching elements, four diodes and one capacitor bank, and wherein the SRM is configured to generate three voltage levels.

17. The method of claim 13, wherein the system further comprises a boosting circuit coupled to the front-end circuit and the back-end circuit.

18. The method of claim 17, wherein the boosting circuit comprises two corresponding switching elements and a boosting capacitor bank, and wherein the method comprises selectively controlling, using the controller, the two corresponding switching elements of the boosting circuit to charge and discharge the boosting capacitor bank.
